(19) United States
(12) Patent Application Publication
(10) Pub. No.: US 2011/0060064 A1
(43) Pub. Date: Mar. 10, 2011

(54) FLAME-RETARDANT, REDUCED-WEIGHT ELASTIC FLEXIBLE POLYURETHANE FOAM

(75) Inventor: Ulrich Heitmann, Memmingen (DE)

(73) Assignee: METZELER SCHAUM GmbH

(21) Appl. No.: 12/936,102

(22) PCT Filed: Mar. 31, 2009
(86) PCT No.: PCT/EP09/53842

§ 371 Date: Nov. 19, 2010

(30) Foreign Application Priority Data
Apr. 1, 2008 (DE) 10 2008 016 610.3

(51) Int. Cl. C08K 5/521; C08K 3/04

(52) U.S. Cl. 521/107; 521/99

(57) ABSTRACT

A flame-retardant elastic polyurethane-soft-foam produced from a foam reaction mixture, comprising a polyol mixture, a polyisocyanate, an expandable graphite as a flame retardant, and additives. In order to reduce density while retaining long-term service properties, the polyol mixture comprises, in terms of parts by weight, from 50% to 90% of EO-based polyol, and from 50 to 10 parts by weight of standard polyol and/or filler polyol.

The invention relates to a flame-retardant, elastic polyurethane-soft-foam produced from a foam reaction mixture, comprising a polyol mixture, a polyisocyanate, an expandable graphite as a flame retardant, and additives.

Such a polyurethane-soft-foam is known from DE 39 09 017 C1 of the present applicant. In the foam reaction mixture used, a polyol mixture, comprising polyetherpolyol and polymer-filled polyol is used. Expandable graphite in the form of flakes is used as a flame retardant, wherein the flakes have the order of magnitude of the resulting foam cell walls and are first admixed to the polyol reaction component. Such flame-retardant polyurethane-soft-foams are primarily used as seat cushions for airplanes or rail vehicles. In addition to stringent requirements with respect to the flame behavior, the foam must also have good long term service properties. In order to fulfill these requirements, the prior art foam has a relatively high density, which leads to increased energy expenditure.

On the basis of the above, it is the object of the present invention to suggest a flame-retardant, elastic polyurethane-soft-foam having reduced weight, while maintaining or increasing the service life.

To achieve this object, in a polyurethane-soft-foam of the initially mentioned type, it is suggested that the polyol mixture comprises 50% to 90% in terms of parts by weight of ethylene-oxide-based polyol (EO polyol) and 50% to 10% standard polyol and/or filler polyol.

The polyurethane-soft-foam according to the present invention has excellent long term service properties and at the same time a low density. Compared to traditional polyurethane-soft-foams, the weight can be reduced by about 30%. This is of advantage, in particular, when the polyurethane-soft-foam is used as a seat cushion for aircraft, since the aircraft weight and thus the fuel consumption can be reduced.

Advantageous embodiments of the invention are defined in the independent claims.

Advantageously, in terms of parts by weight, the ethylene-oxide-based polyol is 80%, and in terms of parts by weight, the standard polyol and/or the filler polyol is 20%.

The polyisocyanate percentage is used with an isocyanate amount corresponding to an index of 90 to 105. Advantageously, a diisocyanate is used.

Advantageously, the proportion of the expandable graphite is 50 to 40 parts by weight, in particular 30 parts by weight, per 100 parts by weight of polyol.

The expandable graphite flame retardant is advantageously present in a particle size of 0.2 to 1 mm.

Advantageously, the expandable graphite flame retardant is present in the form of flakes.

In an advantageous embodiment, it is suggested that, as a further flame retardant, chlorophosphoric acid ester is present with 5 to 15 parts by weight, in particular 10, per 100 parts by weight of polyol.

The additives include in particular water, a catalyst and a stabilizer.

In an advantageous embodiment, the foam reaction mixture comprises:

a) , a polyol mixture with 80% parts by weight of ethylene-oxide-based polyol and 20 parts by weight of standard polyol,

b) an isocyanate amount corresponding to an index of 90 to 105;

c) 30 parts by weight of expandable graphite flame retardant and 10 parts by weight of chlorophosphoric acid ester per 100 parts by weight of polyol.

Advantageously, the density of the polyurethane-soft-foam is 20 to 50 kg/m³.

The invention will be described in more detail in the following with reference to an exemplary embodiment.

Table 1 shows a comparison between the new polyurethane-soft-foam according to the present invention and a comparative foam according to the prior art.

TABLE 1

| | | Comparative foam |
|---|---|---|
| | New foam | (prior art) |
| Polyol 1 | 20 | 80 |
| Polyol 2 | 80 | |
| Polyol 3 | | 20 |
| Water | 6 | 6 |
| Catalyst 1 | 0.6 | 1.5 |
| Catalyst 2 | 0.2 | 0.3 |
| Catalyst 3 | | 0.3 |
| Stabilizer 1 | 1 | |
| Stabilizer 2 | | 2.3 |
| Expandable graphite | 30 | 30 |
| Flame retardant | 10 | 10 |
| Isocyanate | 95 | 95 |

| | |
|---|---|
| Polyol 1 | Standard polyol, e.g. Bayfit 10WF18 |
| Polyol 2 | EO polyol, e.g. Bayfit 41WB01 |
| Polyol 3 | Standard polyol Bayfit 7619 |
| Catalyst 1 | Diethanolamine |
| Catalyst 2 | Bis-2-dimethylaminoethanol |
| Catalyst 3 | Triethylenediamine |
| Stabilizer 1 | Tegostab 4900 (by Evonik) |
| Stabilizer 2 | Tegostab B4690 (by Evonik) |
| Isocyanate | Desmodur 3230 (by Bayer) |

The polyurethane-soft-foam according to the present invention has the composition shown in the left column. As can be seen, the polyol mixture consists of a standard polyol (polyol 1) and an ethylene-oxide-based polyol (polyol 2). For the comparative foam, however, a polyol mixture consisting of a standard polyol (polyol 1) and a further standard polyol (polyol 3) is used, as can be seen in the right column of Table 1.

The catalysts and stabilizers used are the same for both foams.

A diisocyanate, is used having an isocyanate amount corresponding to an index of 90 to 105.

The physical properties of the new foam and of two comparative foams with different densities can be seen from Table II.

TABLE II

| | 1. New | 2. Comparative | 3. Comparative |
|---|---|---|---|
| | foam density | foam density | foam density |
| | 40 kg/m³ | 40 kg/m³ | 65 kg/m³ |
| Compression set, | 8% | 35% | 7% |
| DIN EN ISO 1856, | | | |
| method A 18 h; 70° C.; | | | |
| 50% | | | |
| Wet compression set | 6% | 40% | 7% |
| DIN EN ISO 1856, | | | |
| method C 7 d; 40° C.; | | | |
| 80% rf; 50% | | | |
| Fatigue test | | | |
| DIN EN ISO 3385 | | | |
| Hardness loss | 12% | 30% | 12% |
| Height loss | 3% | 15% | 4% |

The polyurethane-soft-foam according to the present invention has a density of 40 kg/m³. The physical values such as compression set according to DIN EN ISO 1856, wet compression set according to DIN EN ISO 1856 and fatigue test according to DIN EN ISO 3385 can be derived from column 1.

As can be derived from comparison with column 2, the prior art comparative foam has substantially poorer physical properties, while the density of 40 kg/m³ is the same.

To achieve similar physical properties, the comparative foam has to have a density of 65 kg/m³, as can be seen from column 3. The polyurethane-soft-foam according to the present invention thus has a weight reduced by about 30%, while the physical properties remain the same.

The reduced density is advantageous, in particular, for the use of the foam as cushions in aircraft and rail vehicles, since energy expenditure can be reduced. In addition to its use as cushions in aircraft and rail vehicles, the foam according to the present invention can also be used in mattresses, which are used in security areas, such as prisons.

The manufacture of the foam is carried out according to the method described in DE 39 09 017 C1.

1. A flame-retardant, elastic, polyurethane-soft-foam, produced from a foam reaction mixture, comprising:
a) a polyol mixture;
b) a polyisocyanate;
c) expandable graphite as a flame retardant;
d) additives,
wherein the polyol mixture comprises 50% to 90% parts by weight of ethylene-oxide-based polyol and 50% to 10% parts by weight of standard polyol and/or filler polyol.

2. The polyurethane-soft-foam according to claim 1, wherein the weight percentage of the ethylene-oxide-based polyol is 80% and the weight percentage of the standard polyol and/or the filler polyol is 20%.

3. The polyurethane-soft-foam according to claim 1 wherein the polyisocyanate percentage is present with an isocyanate amount corresponding to an index of 90 to 105.

4. The polyurethane-soft-foam according to claim 1, wherein the expandable graphite percentage is 5 to 40 parts by weight, per 100 parts by weight of polyol.

5. The polyurethane-soft-foam according to claim 1, wherein the expandable graphite flame retardant is present with a particle size of 0.2 to 1 mm.

6. The polyurethane-soft-foam according to claim 1, wherein the expandable graphite flame retardant is present in the, form of flakes.

7. The polyurethane-soft-foam according to claim 1, wherein, as a further flame retardant, chiorophosphoric acid ester is present with 5 to 15 parts by weight, per 100 parts by weight of polyol.

8. The polyurethane-soft-foam according to claim 1, wherein the additives include water, a catalyst and a stabilizer.

9. The polyurethane-soft-foam according to claim 1, comprising a foam reaction mixture, including:
a) a polyol mixture with 80% parts by weight of EO based polyol and 20% parts by weight of standard polyol and/or filler polyol;
b) a polyisocyanate with an isocyanate amount corresponding to an index of 90 to 105;
c) 30% parts by weight of expandable graphite flame retardant, and 10 parts by weight of chlorophosphoric acid ester per 100 parts by weight of polyol.

10. The polyurethane-soft-foam according to claim 1, wherein the density of the polyurethane-soft-foam is 20 to 50 kg/m³.

11. The polyurethane-soft-foam according to claim 1, the expandable graphite percentage is 30 parts by weight per 100 parts by weight of polyol.

12. The polyurethane-soft-foam according to claim 1, as a further flame retardant, chlorophosphoric acid ester is present with 10 parts by weight per 100 parts by weight of polyol.
